(19) United States
(12) Patent Application Publication
(10) Pub. No.: US 2005/0054299 A1
(43) Pub. Date: Mar. 10, 2005

(54) Silent communicator

(76) Inventors: Carl Hein, Cherry Hill, NJ (US); Gregory W. Barnett, Merchantville, NJ (US)

Correspondence Address: DUANE MORRIS LLP, PO BOX 5203, PRINCETON, NJ, 08543-5203, US

(21) Appl. No.: 10/659,172

(22) Filed: Sep. 10, 2003

(51) Int. Cl. H04Q 7/32

(52) U.S. Cl. 455/67.11

(57) ABSTRACT

A communication method and apparatus includes a transmitter of radio-frequency electromagnetic energy (RF) at a first location. A passive, modulated reflector at a second location reflects incident RF, and is modulated by information to be communicated. The reflected RF thus includes the information. A receiver remote from the reflector receives the reflected, modulated RF and extracts the information therefrom. The receiver may be co-located with the transmitter.

### FIELD OF THE INVENTION

This invention relates to communications, and more particularly to communication of information from one location to another by way of radio-frequency energy reflection.

### BACKGROUND OF THE INVENTION

Current methods of communication of information from a location by means of radio-frequency electromagnetic energy often require the transmission of energy from the location. This transmission may be undesired, as it may allow the source of the transmission to be identified, and in any case the transmission of energy requires that a source of energy be available for the transmission. When the amount of energy available for transmission is small, the range of the information communication may be limited.

Improved information communication is desired.

### SUMMARY OF THE INVENTION

A communication method according to an aspect of the invention comprises the steps of transmitting radio-frequency energy (RF) from a first location, and, at a second location remote from the first location, modulating the reflectivity of a passive radio-frequency energy reflector in response to information to be transmitted. As a result, or whereby, modulated radio-frequency energy is reflected by the reflector. The reflected energy, with its information modulation, is received at a third location.

In one version of this aspect of the invention, the third location coincides with the first location. The step of modulating may include the step of at least one of modulating the amplitude and phase of the radio-frequency energy. The step of receiving may be performed with the aid of knowledge of the at least one of the amplitude and phase used at the reflector to modulate the information. The step of receiving may be performed with the aid of mutual synchonization.

An apparatus for stealthy information communication according to another aspect of the invention comprises a transmitter of radio-frequency energy at a first location, and a controllable passive reflector of the radio-frequency energy at a second location, remote from the first location. As a result, or whereby, the reflector reflects reflected radio-frequency energy. A modulator is provided for controlling the controllable reflector with, or in response to, the information, whereby the reflected radio-frequency energy is modulated. The apparatus also includes a receiver remote from the reflector, which is coupled for receiving the modulated radio-frequency energy, and for extracting the information therefrom.

In a particular embodiment of the apparatus according to this other aspect of the invention, the location of the receiver is remote from the first location. The modulator may modulate at least one of amplitude and phase of the radio-frequency energy. Synchronization may be provided between the modulator and the receiver.

### BRIEF DESCRIPTION OF THE DRAWING

FIG. 1 is a simplified block diagram of a communication apparatus according to an aspect of the invention.

### DESCRIPTION OF THE INVENTION

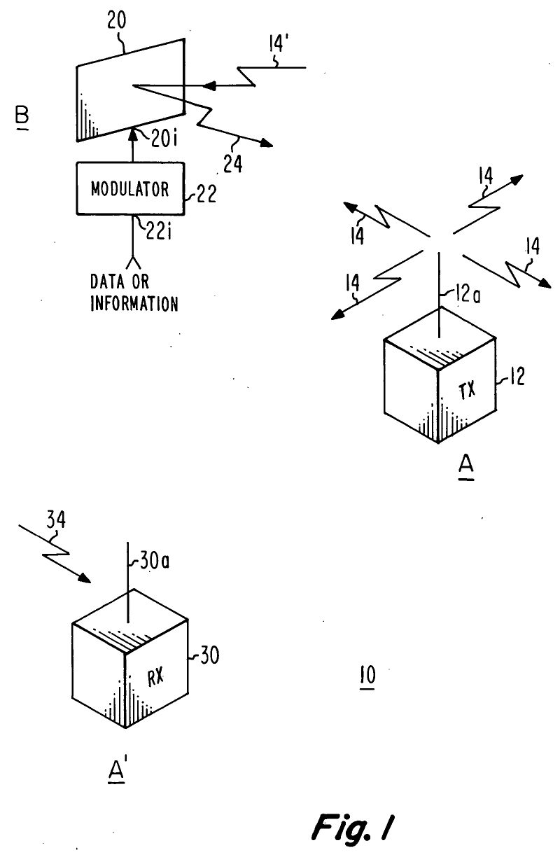

In FIG. 1, a communication system designated generally as 10 includes a transmitter (Tx) 12, which radiates radio-frequency electromagnetic energy (RF) or radiation from an antenna 12a at a first location A. In FIG. 1, the transmitted electromagnetic radiation 14 is illustrated as being transmitted generally omnidirectionally in the horizontal plane, with some of the transmitted energy 14 flowing toward a second location B.

At location B in FIG. 1, a controllable passive reflector 20 of radio-frequency electromagnetic radiation reflects at least that portion, illustrated as 14′, of the transmitted radio-frequency radiation which falls thereon. The reflected radio-frequency energy is illustrated as 24. Those skilled in the art know that reflection is never perfect, and some loss will inevitably occur. A passive reflector is one which does not radiate more energy than impinges thereupon. In this sense, the reflector may be stated to be “inactive” or “not active.”

The radio-frequency electromagnetic energy 24 reflected by reflector 20 of FIG. 1 will retain many of the characteristics of the transmitted radio-frequency energy 14′ impinging thereupon. In particular, the frequency and bandwidth of the impinging radio-frequency electromagnetic energy tend to be maintained, and any modulation of the radio-frequency electromagnetic energy as transmitted at location A will also accompany the reflected radio-frequency electromagnetic energy 24.

Reflector 20 of FIG. 1 can be modulated by information signals applied to its input port 20i from a modulator 22. The modulator produces modulating signals in response to information signals or data applied to its input port 22i. The modulation of the reflector 20 in response to local data or information changes or affects at least one of the amplitude and phase of the radio frequency electromagnetic energy 14′ arriving or impinging thereon. Consequently, the radio-frequency electromagnetic energy 24 reflected by reflector 20 is modulated (or additionally modulated) by the information or data applied to modulator 22.

In FIG. 1, a receiver (Rx) 30 at a location A′ receives, by way of its antenna 30a, a portion 34 of the reflected, information-modulated signals 24 from reflector 20. Receiver 30 may also receive some signals from transmitter 12. With knowledge of the type of modulation used by modulator 22, receiver 30 extracts the information modulated thereon. For example, if transmitter 12 transmits radio-frequency electromagnetic signals which are frequency-modulated, and reflector 20 uses amplitude modulation, receiver 30 can simply detect the amplitude modulation of the signals received at that frequency to extract the information modulated thereon at the location B of reflector 20.

Thus, an apparatus (10) for stealthy information communication according to an aspect of the invention comprises a transmitter (12) of radio-frequency energy at a first location (A), and a controllable passive reflector (20) of the transmitted radio-frequency energy (14) at a second location (B), remote from the first location (A). As a result, or whereby, the reflector (20) reflects reflected radio-frequency energy (24). A modulator (22) is provided for controlling the controllable reflector (20) with, or in response to, the information, whereby the reflected radio-frequency energy (24) is modulated. The apparatus (10) also includes a receiver (30) remote from the reflector (20), which is coupled for receiving the modulated radio-frequency energy (34), and for extracting the information therefrom.

In a particular embodiment of the apparatus according to this other aspect of the invention, the location (A′) of the receiver is remote from the first location (A). The modulator (22) may modulate at least one of amplitude and phase of the radio-frequency energy.

1. A communication method comprises the steps of:
transmitting radio-frequency energy from a first location;
at a second location remote from said first location, modulating the reflectivity of a passive radio-frequency energy reflector in response to information to be transmitted, whereby modulated radio-frequency energy is reflected by said reflector; and
receiving said modulated radio-frequency energy at a third location remote from said second location.

2. A method according to claim 1, wherein said third location coincides with said first location.

3. A method according to claim 1, wherein said step of modulating includes the step of at least one of modulating the amplitude and phase of said radio-frequency energy.

4. A method according to claim 3, wherein said step of receiving is performed with the aid of knowledge of said at least one of said amplitude and phase.

5. A method according to claim 1, wherein said step of receiving is performed with the aid of knowledge of the modulation.

6. A method according to claim 1, wherein said step of receiving is performed with the aid of mutual synchronization.

7. An apparatus for stealthy information communication, said apparatus comprising:
a transmitter of radio-frequency energy at a first location;
a controllable passive reflector of said radio-frequency energy at a second location, remote from said first location, whereby said reflector reflects reflected radio-frequency energy;
a modulator for controlling said controllable reflector with said information, whereby said reflected radio-frequency energy is modulated; and
a receiver remote from said reflector, and coupled for receiving said modulated radio-frequency energy, and for extracting said information therefrom.

8. An apparatus according to claim 7, wherein the location of said receiver is remote from said first location.

9. An apparatus according to claim 7, wherein said modulator modulates at least one of amplitude and phase of said radio-frequency energy.

10. An apparatus according to claim 7, further comprising synchronization between said modulator and said receiver.
